(19) United States
(12) Patent Application Publication
(10) Pub. No.: US 2007/0054525 A1
(43) Pub. Date: Mar. 8, 2007

(54) Packaging System With An Improved Locking Mechanism

(76) Inventors: Marty Jones, Graham, NC (US); Michael Weston, Chapel Hill, NC (US); Billy Baxter, Burlington, NC (US)

Correspondence Address: PARKS KNOWLTON LLC, 1117 PERIMETER CENTER WEST, SUITE E402, ATLANTA, GA, 30338, US

(21) Appl. No.: 11/470,875

(22) Filed: Sep. 7, 2006

Related U.S. Application Data
(60) Provisional application No. 60/715,389, filed on Sep. 8, 2005.

(51) Int. Cl. H01R 13/62

(52) U.S. Cl. 439/159

(57) ABSTRACT

A package includes a slide card that can be releasably locked in an outer sleeve. The slide card includes an engaging tab that provides part of a locking mechanism that is used to lock the slide card in the outer sleeve. A hub is positioned and secured to the engaging tab to maintain the structural integrity of the engaging tab. The distal edge of the hub defines an engaging edge of the engaging tab and prevents the engaging tab from being compromised by bending or folding.

### RELATED APPLICATIONS

This application claims priority to U.S. Application No. 60/715,389, filed Sep. 8, 2005, the entirety of which is incorporated herein by reference.

### FIELD OF THE INVENTION

The invention relates to a packaging system for packaging and dispensing articles and, more specifically, to a packaging system that includes an outer sleeve with an inner structure that provides additional security to articles that are located on an interior slide card.

### BACKGROUND OF THE INVENTION

A known packaging system for packaging blisters packs and other articles includes a slide card that is received in an outer sleeve. Such a packaging system is a convenient packaging format for certain pharmaceutical applications because the slide card can be repeatedly removed from and returned to the outer sleeve in order to dispense unit doses from the blister pack. The packaging system functions to provide child resistance for the blister pack. Specifically, the blister pack is secured, mounted, or integral to the slide card, which can be lockably retained within the outer sleeve by a locking mechanism and released from the outer sleeve by a release mechanism. Further, operation of the release mechanism in order to release the blister package from the outer sleeve requires a set of actions that are counter-intuitive to a child.

Child resistance is a feature particularly desired for pharmaceutical packaging and, with regard to certain products, is mandated by the Poison Prevention Packaging Act of 1970. For example, to achieve a desired child resistance (CR) rating of F=1, the number of subject packages that are compromised by children of a specific age may not exceed a pre-set failure rate. This general guideline is designed to ensure that the package has sufficient integrity against tampering by children.

Although many packaging systems include child-resistant locking features, the locking mechanism of some packaging systems includes elements that are formed from materials that may deform or delaminate with repeated use or are otherwise structurally weak. In such packaging systems the locking mechanism can be disengaged to remove the slide card from the outer sleeve without properly operating the release mechanism. Thereby the blister package can be inadvertently released from the outer sleeve.

Accordingly, there remains in the art a need for a packaging system that facilitates easy access to articles by the intended user and that has an improved locking mechanism so as to be less susceptible to manipulation by an unintended user, such as a child.

### SUMMARY OF THE INVENTION

The present invention overcomes the deficiencies of the known art and the problems that remain unsolved, by providing a packaging system that includes an improved slide card which is received in an outer sleeve. The improved slide card includes a hub that is attached to an engaging tab of the slide card. The engaging tab is an element of a locking mechanism for locking the slide card in the outer sleeve. The hub improves the structural integrity of the engaging tab and at least partially defines a robust engaging edge for the engaging tab such that the engaging tab can repeatedly engage other locking elements without being compromised.

In the exemplary embodiments, the packaging system includes elements that provide a locking feature for retaining the slide card within the outer sleeve as well as elements that provide a release mechanism for releasing the slide card from the locking feature. Thereby, the slide card can be repeatedly removed to dispense articles to an intended user and reinserted in the outer sleeve to prevent the articles from being dispensed to an unintended user. In the exemplary embodiments, the elements that provide the locking feature include an engaging tab of the slide card and an engaging aperture of the outer sleeve. The engaging edge of the engaging tab engages an edge of the engaging aperture to releasably lock the slide card in the outer sleeve. The elements that provide the release mechanism include a release button of the outer sleeve that can be pressed to disengage the engaging edge of the engaging tab from the edge of the engaging aperture such that the slide card can be at least partially removed from the outer sleeve.

A hub is secured to the engaging tab and positioned relative to the engaging tab such that the distal edge of the hub at least partially provides the engaging edge of the engaging tab. In certain embodiments, the distal edge of the hub is the distalmost edge of the hub. In other embodiments, the distal edge of the hub is substantially aligned with the distal edge of the engaging tab to define the engaging edge of the engaging tab.

In certain embodiments, the hub includes a protrusion and the engaging tab includes an aperture such that the hub is positioned relative to the engaging tab as the protrusion is received in the aperture. In other embodiments, the engaging tab includes slits that receive corresponding corners of the hub and thereby position the distal edge of the hub relative to the distal edge of the engaging tab. It should be understood that the hub and engaging tab can each include any number and combination of elements that combine to position the hub relative to the engaging tab including slits, apertures, protrusions, edges, depressions, and the like. Further, these elements can provide means for securing the hub to the engaging tab as described in further detail below.

In alternative embodiments the slide card may be configured to hold articles on structures other than a blister pack, such as a tray as taught in one or more co-pending applications that claim priority to U.S. provisional patent application No. 60/591,677, and incorporated herein by reference. Still other alternative embodiments include articles attached directly to the slide card, without first being placed in primary packaging.

### BRIEF DESCRIPTION OF THE DRAWINGS

FIG. 1 is a plan view of an exemplary embodiment of a blank for forming an outer sleeve, according to the present invention.

FIG. 2 is a perspective view of a partially erected outer sleeve that is formed from the blank of FIG. 1.

FIG. 3 is a perspective view of components for forming an exemplary embodiment of a slide card, according to the present invention.

FIG. 4 is a perspective view of a slide card formed from the components of FIG. 3.

FIG. 5 is a perspective view of a fully erected outer sleeve that is formed from the blank of FIG. 1 which is shown to receive the slide card of FIG. 4 to form an exemplary package, according to the present invention.

FIG. 6 is a plan view of a blank for forming an alternative embodiment of an outer sleeve, according to the present invention.

FIG. 7 is a plan view of a blank for forming an alternative embodiment of a slide card, according to the present invention.

FIG. 8 is a perspective view of a slide card formed from the blank of FIG. 7.

FIG. 9 is a perspective view of an outer sleeve that is formed from the blank of FIG. 6 which is shown to receive the slide card of FIG. 8 to form an exemplary package, according to the present invention.

FIG. 10 is a plan view of a blank for forming an alternative embodiment of a slide card, according to the present invention.

FIG. 11 is a perspective view of a slide card formed from the blank of FIG. 10.

### DETAILED DESCRIPTION

As required, detailed embodiments of the present invention are disclosed herein. It must be understood that the disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, specific structural and functional details disclosed herein are not to be interpreted as limiting, but merely as a basis for the claims and as a representative basis for teaching one skilled in the art to variously employ the present invention.

The present invention is applicable to the packaging, storing, and dispensing of various products. Specifically, the invention is illustrated in the context of a package that includes slide card that can be releasably locked in an outer sleeve. The illustrated package can provide primary or secondary packaging for many different products and especially for products that require child-resistant packaging. For example, in certain of the embodiments described herein, the present invention provides secondary packaging for blister packs that are secured to or integral to the slide card to be releasably locked in an outer sleeve. In other embodiments, a tray for receiving a product that is integral to or directly attached to the slide card.

Referring now to the drawings in which like numerals indicate like elements throughout the several views, the drawings illustrate certain of the various aspects of exemplary embodiments of a package that includes a slide card and an outer sleeve, according to the present invention. In the embodiments described herein, the slide card includes an engaging tab to which a hub is secured. A distal end of the hub is positioned relative to the distal end of the engaging tab so as to define the engaging edge of the engaging tab. Further, the hub provides structural support to the engaging tab such that the engaging tab is not deformed as the slide card is repeatedly locked and released in the outer sleeve.

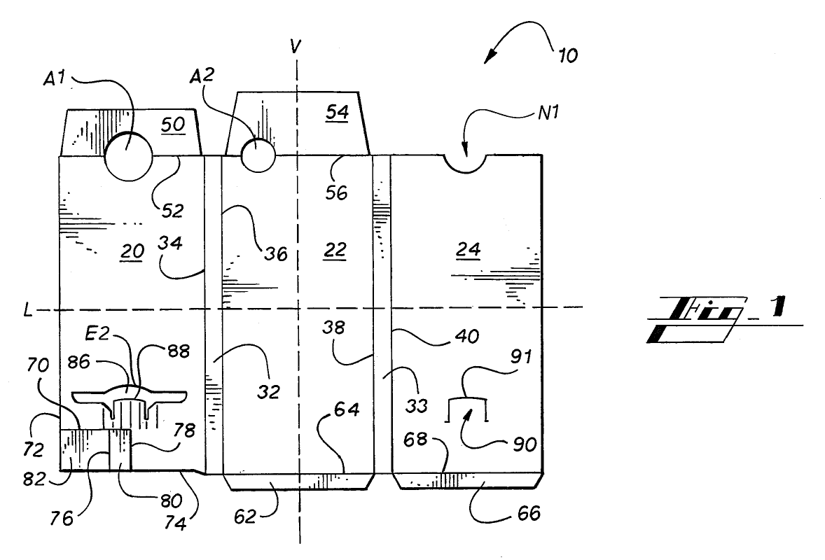

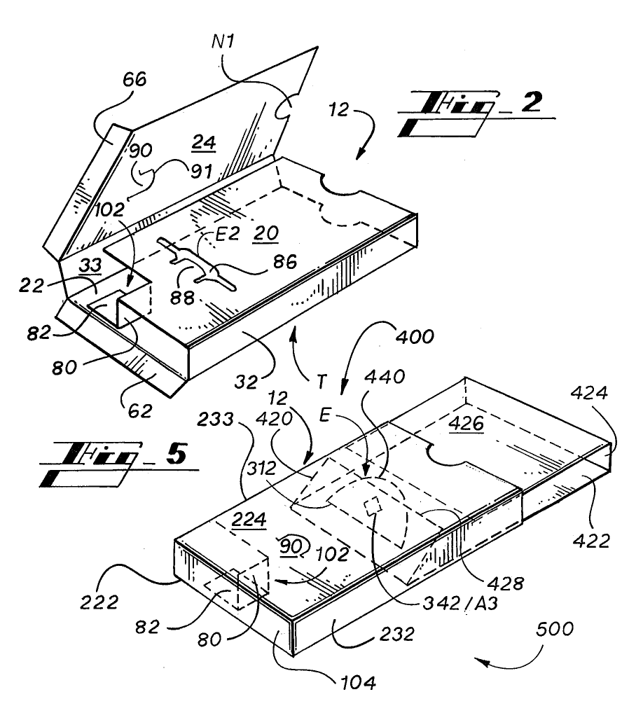

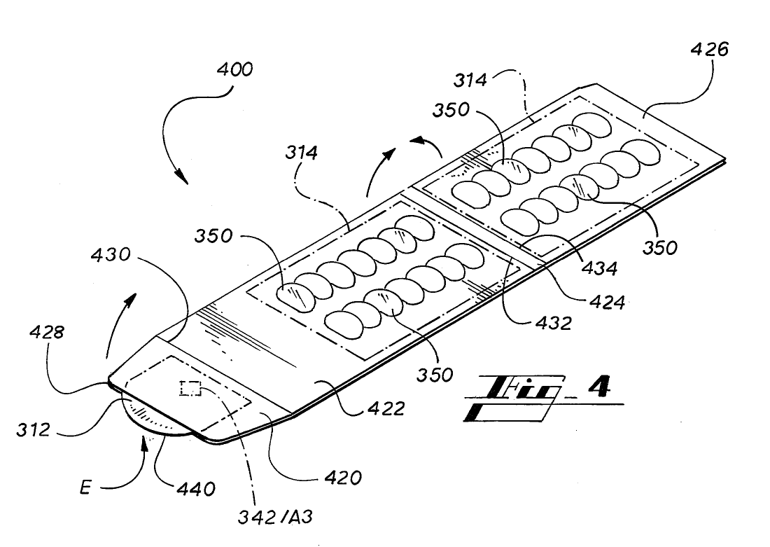

Referring to FIG. 1, a plan view of an exemplary embodiment of a blank 10 for forming an outer sleeve 12 (shown in FIGS. 2 and 5) is shown. Generally described, the blank 10 is formed from a foldable sheet material such as paperboard, corrugated board, plastic, cardboard, any other flexible and durable material or combination thereof, and the like. The selection of this material may be made according to the packaging needs. For example, a material selected for medicines should be recognized as safe by the Food and Drug Administration. In certain preferred embodiments, the material may be selected from a sheet of bleached sulfate board, a sheet of solid unbleached sulfate board (SUS), clay-coated newsback (CCNB), or any other suitable board material. In other examples, the paperboard may be clay coated on one side (C1S) or both sides (C2S) with a coating such as a fluidized blend of mineral pigments. The mineral pigments may be coating clay, calcium carbonate, or titanium dioxide and may be combined with starch or adhesive. Successive densification and polishing (via calendering) finishes each coated surface to a high degree of smoothness and renders it suitable for printing graphics of superior quality. Text or graphic information may be printed on the outer sleeve 12 or on the surface of the slide card according to any means conventionally known in the art. Similarly, a slide card blank 310 (shown in FIG. 3) can be formed from foldable sheet material, as described above.

At least a part of one or both sides of the blank 10 may be laminated with a polymer film. In this manner, the outer sleeve 12 is made more resistant to tearing. Optionally, this lamination may not extend over the entire surface of the blank 10 since only tear prone regions of the outer sleeve 12 may require lamination. Suitable laminating materials may be selected from biaxially oriented or cross-laminated polymeric films such as high density polyethylene (HDPE), polyolefins, polyesters, or combinations thereof. In a related embodiment, tear resistance may be provided at stress points, such as the corners and exposed edges of the outer sleeve 12, by applying one or more strips of polymeric film over these areas. The polymeric film may be applied by extrusion, adhesive lamination, or by any other suitable means known in the art. Polymeric film is typically applied to the side that is the interior surface of the blank 10. Similar lamination with polymeric film may be used to treat the surface of a slide card.

The blank 10 includes a number of primary panels that are substantially rectangular and that are aligned along the longitudinal axis L of the blank 10. For reference, a transverse axis V is provided to illustrate a transverse direction, which is substantially perpendicular to the longitudinal axis L. The primary panels are folded and secured to form a tubular structure, as described in further detail below. The primary panels are hingedly connected one to the next along transverse fold lines, which are substantially perpendicular to the longitudinal axis L of the blank 10. The primary panels of the blank 10 include an inner panel 20, a bottom panel 22, a top panel 24, and side panels 32, 33. The panels 20, 22 are hingedly connected to opposite edges of the first side panel 32 along fold lines 34, 36. The panels 22, 24 are hingedly connected to opposite edges of the second side panel 33 along fold lines 38, 40.

The blank 10 further includes a number of extension panels that are hingedly connected to an end edge of certain primary panels along fold lines that are substantially parallel to the longitudinal axis L of the blank 10. An inner extension panel 50 is hingedly connected to the inner panel 20 along a fold line 52 and a bottom extension panel 54 is hingedly connected to the bottom panel 22 along a fold line 56. Apertures A1, A2 are disposed in the blank 10 so as to interrupt fold lines 52, 56 and thereby each aperture A1, A2 is partially disposed in a respective primary panel and partially disposed in a respective extension panel. Specifically, aperture A1 is partially disposed in inner panel 20 and partially disposed in inner extension panel 50. Aperture A2 is partially disposed in bottom panel 22 and partially disposed in bottom extension panel 54. In addition, the top panel 24 includes a notch N1. When the extension panels are folded relative to the respective primary panels, the apertures define notches which facilitate removing the slide card from the outer sleeve. The notches are positioned relative to one another to provide child resistance, as described in further detail below.

End wall panels are hingedly connected to an end edge of certain primary panels along fold lines that are substantially parallel to the longitudinal axis L of the blank 10. The end wall panels can be folded and secured as described below to form an end closure structure at an open end of the tubular structure defined by certain primary panels and thereby define an end wall of the outer sleeve 12. A first end wall panel 62 is hingedly connected to the bottom panel 22 along a fold line 64 and a second end wall panel 66 is hingedly connected to the top panel 24 along a fold line 68.

The blank 10 includes elements that define a false end wall 102 (shown in FIGS. 2 and 5) in the outer sleeve 12 when folded and secured as described below. In the exemplary embodiment, a plurality of panels for forming a false end wall 102 are defined in the inner panel 20 by a cut line 70 and two fold lines 76, 78. Specifically, a false bottom panel 80 is at least partially defined by the fold lines 76, 78 and the cut line 70. In addition, a glue flap 82 is at least partially defined by the fold line 76 and the cut line 70. The cut line 70 extends from a transverse free edge 72 of the inner panel 20 toward the fold line 34 and is orientated substantially parallel to a longitudinal free edge 74 of the inner panel 20. The first fold line 76 and the second fold line 78 extend between the longitudinal free edge 74 and the cut line 70. Specifically, the second fold line 78 extends transversely between the distal end of the cut line 70 and the longitudinal free edge 74. The first fold line 76 is offset from and substantially parallel to the second fold line 78.

The top panel 24 and the inner panel 20 include elements that at least partially define a locking mechanism and a release mechanism of the outer sleeve 12, as described in further detail below. The top panel 24 includes a release button 90 that is defined by a contoured cut line 91 and the inner panel 20 includes an engaging aperture 86 that defines a node 88 and an edge E2. The release button 90 and engaging aperture 86 are disposed in their respective panels 24, 20 such that when the top panel 24 overlaps the inner panel 20, as described in further detail below, the release button 90 functionally aligns with the node 88.

It is envisaged that, in any embodiment of the present invention, the carton can be formed from a blank by a series of sequential folding and gluing operations, which can be performed by a straight-line automatic packaging machine so that the carton is not required to be rotated or inverted to complete its construction. It is also envisaged that the series of sequential folding and gluing operations can be manually performed. The folding process is not limited to that described below and can be altered according to particular manufacturing or user requirements. In addition, alternative embodiments may be made from multiple individual blanks, panels, or panel portions, rather than the illustrated single blank, without varying from the scope of the claims.

Turning now to the erection of the blank 10, it will be understood by those skilled in the art that the particular sequences of folds discussed below are neither limiting nor the only sequence of folds possible to erect the outer sleeve 12 from the blank 10. The blank 10 may be initially folded to form a collapsed tubular structure with a collapsed false end wall such that the collapsed tubular structure and collapsed false end wall can be simultaneously erected to form the outer sleeve 12 having the false end wall 102, best shown in FIG. 2. Arranging the outer sleeve 12 in a collapsed condition facilitates shipping or stacking the outer sleeve 12. For purposes of clarity, the side or surface of the blank 10 that is shown in FIG. 1 is designated as the outside surface of the blank 10 and the opposite side is designated as the inside surface of the blank 10.

According to a first exemplary method for forming a collapsed tubular structure with a collapsed false end wall, the inner extension panel 50 and the bottom extension panel 54 are folded along respective fold lines 52, 56 such that the inside surface of each of the extension panels 50, 54 is substantially in a face contacting arrangement with the inside surface of the panels 20, 22, respectively. The bottom extension panel 54 can be optionally secured to the bottom panel 22. Adhesive is applied to the inside surface of the glue flap 82 and the inner panel 20 is folded along fold line 34 such that the inside surface of the glue flap 82 is secured to the inside surface of the bottom panel 22. Adhesive is further applied to the outside surface of the inner panel 20 and the blank 10 is folded along fold line 38 such that the inside surface of top panel 24 overlaps and is secured in a face contacting arrangement with the outside surface of the inner panel 20.

The collapsed tubular structure, which is formed from the method described above, can be erected to form the outer sleeve 12, best shown in FIGS. 2 and 5, by pulling the bottom panel 22 from the inner panel 20 such that the panels 20, 22, 24 are substantially parallel to one another and substantially perpendicular to each of the side panels 32, 33. In addition, a false end wall 102 is erected as the bottom panel 22 is pulled from the inner panel 20 such that the false bottom panel 80 is substantially perpendicular to the panels 20, 22 and substantially parallel to the side panels 32, 33. When arranged as a tubular structure, the top panel 24 and the inner panel 20 define a composite top wall 224, the bottom panel 22 defines a bottom wall 222, and the side panels define side walls 232, 233. To complete the folding sequence for the outer sleeve 12, the end panels 62, 66 are folded and secured to form an end closure structure that defines an end wall 104 of the outer sleeve 12, as shown in FIG. 5.

It should be noted that the outer sleeve 12 illustrated in FIG. 2 is partially formed in that the top panel 24 is not shown as being secured to the inner panel 20. FIG. 2 is illustrated in this manner to best show certain elements of the outer sleeve 12.

An exemplary slide card is now described which is suitable for use with the outer sleeve 12. Slide cards with means for packaging or receiving and securing an item, including those that hold blisters, those with integral trays, those with trays mounted thereon, and those with articles mounted directly thereon, are known or have been developed by the Applicant and are the subject of issued patents and/or co-pending applications. However, the present invention is not limited to the exemplary embodiments of slide cards described herein or previously developed by the Applicant. Rather, the scope of the invention includes any slide card that includes a hub which provides structural integrity to and an engaging edge for an engaging tab of the slide card, as described in further detail below.

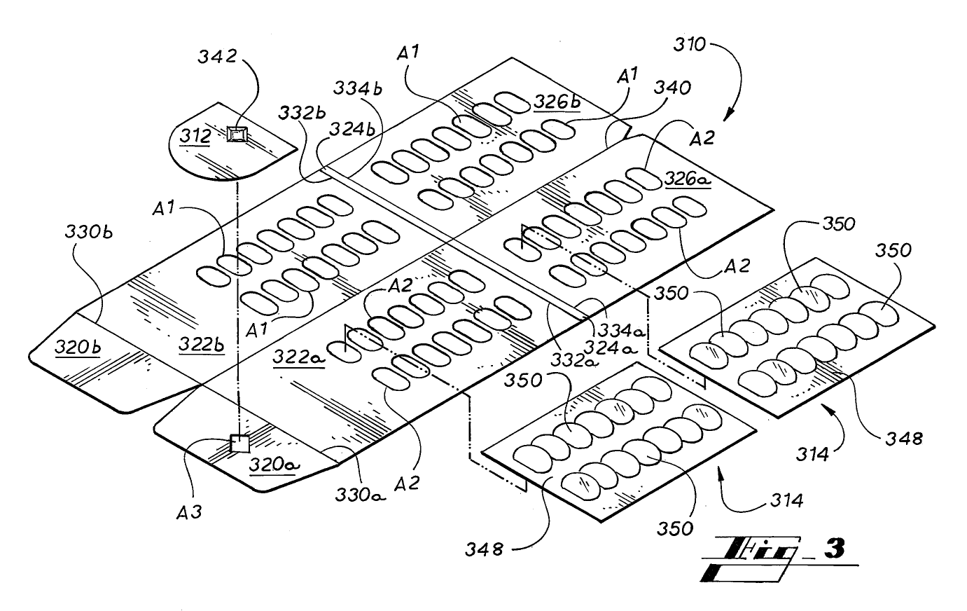

Referring now to FIG. 3, exemplary embodiments of a slide card blank 310, a hub 312, and blister packs 314 can be assembled to form an exemplary slide card 400, best shown in FIG. 4. The slide card blank 310 includes a first series of panels aligned in a longitudinal direction which are hingedly connected to one another along fold lines which are oriented in a transverse direction. The first series of panels includes an engaging tab 320a, a base panel 322a, a spine panel 324a, and a cover panel 326a. The engaging tab 320a is hingedly connected to the base panel 322a along a fold line 330a, the base panel 322a is hingedly connected to the spine panel 324a along a fold line 332a, and the spine panel 324a is hingedly connected to the cover panel 326a along a fold line 334a. The exemplary embodiment of the slide card blank 310 further includes a second series of panels that are substantially similar to the first series of panels. Further, certain of the first series of panels are hingedly connected to respective ones of the second series of panels along a fold line 340. The second series of panels include an engaging tab 320b, a base panel 322b, a spine panel 324b, and a cover panel 326b that are hingedly connected one to the next along fold lines 330b, 332b, 334b. Thus, the base panels 322a, 322b are hingedly connected along fold line 340, the spine panels 324a, 324b are hingedly connected along fold line 340, and the cover panels 326a, 326b are hingedly connected along fold line 340. The slide card blank 310 can be folded along the fold line 340 to form a two ply thick slide card 400, as described in further detail below.

In the exemplary embodiment, the base panel 322b and the cover panel 326b each include a pattern of apertures A1. The base panel 322a and the cover panel 326a each include a similar pattern of apertures A2. Further, the engaging tab 320a includes an aperture A3. These elements will be described in further detail below as they relate to elements of the hub 312 and of the blister pack 314.

The hub 312 includes a protrusion 342 that is dimensioned to be securely received in the aperture A3. In the exemplary embodiment, the protrusion 342 and the aperture A3 each have a diamond or square shape. This shape provides that, as the protrusion 342 is received in the aperture A3, the movement of the hub 312 is restricted. Specifically, the hub 312 is prevented from rotating or translating in the plane defined by the engaging tab 320a. It should be understood that the protrusion 342 and the aperture A3 can have any shape that constrains the movement of the hub 312 as described above including, but not limited to, a rectangle, a triangle, a semi-circle, a star, a cross, any shape with at least one corner, and the like. In other embodiments, an engaging corner is not necessary because the hub is secured to the engaging tab by mechanical fasteners or chemical fastening. For example, a circular hub and circular aperture A3 can be used, and the hub may spin freely.

The protrusion 342 extends from the plane defined by the hub 312 for a distance that is substantially equal to the thickness of the engaging tab 320a such that the distal end of the protrusion 342 is flush with the outside surface of the engaging tab 320a. For clarity, the inside surface of the blank 310 is shown in FIG. 3. It should be understood that, in alternative embodiments, the engaging tab can include a protrusion and the hub can include an aperture that receives the protrusion to at least partially position the hub relative to the engaging tab. The hub can be secured to the slide card blank by means for securing including adhesive, mechanical fasteners, chemical bonding, slits for receiving corners, Velcro®, tape, a combination thereof, and the like.

The blister pack 314 includes a flange portion 348 from which blisters 350 extend. Blister packs 314 can be formed in numerous ways including by thermoforming blisters 350 in a sheet of plastic-type material and attaching a foil or paperboard backing to the sheet of plastic-type material to enclose the cavities defined by the blisters 350. Thereby, the flange portion 348 is the composite planar portion of the blister pack 314 that is formed by the backing and the planar portion of the sheet material. The blisters 350 are sized and dimensioned to receive products, such as medicaments. In the exemplary embodiment, the blisters 350 are arranged in a matrix configuration having two columns and seven rows, but this configuration is merely a design choice. The products in each of the blisters 350 are accessible through the backing of the blister pack 314. For example, a foil backing can be broken or a paperboard backing can include detachable gates in order to access articles in blisters 350.

In the exemplary embodiment, the hub 312 and the blister packs 314 are secured between respective panels of the first series of panels, designated by the suffix “a”, and the second series of panels, designated by the suffix “b”, as the slide card blank 310 is folded along the fold line 340. Specifically, the surface of the flange portion 348 of a blister pack 314 is disposed in a face contacting arrangement with the inside surface of the base panel 322a and the surface of the flange portion 348 of another blister pack 314 is disposed in a face contacting arrangement with the inside surface of the cover panel 326a. Further, the blisters 350 of each blister pack 314 are aligned with the apertures A2 on respective panels 322a, 326a.

The apertures A2 are dimensioned and positioned to align with the blisters 350 such that articles in the blisters 350 can be accessed therethrough. In alternative embodiments, the panels 322a, 326a can provide at least a portion of the backing of the blister pack 314. In other words, the blister pack 314 can be integral to the slide card blank 310. For example, blisters 350 can be formed from a sheet of material, as described above, and the planar portion of the sheet of material can be secured to the panels 322a, 326a of the slide card blank 310 such that the blisters align with gates or other features that can be substituted for the apertures A2.

The apertures A1 are dimensioned and positioned to receive blisters 350 of the blister pack 314 as the slide card blank 310 is folded along the fold line 340 such that the flange portions 348 of the blister packs 314 are sandwiched between the base panels 322a, 322b and between the cover panels 326a, 326b. In addition, as the slide card blank 310 is folded along the fold line 340, the hub 312 is sandwiched between the engaging tabs 320a, 320b. It should be noted that adhesive can be applied to the inside surface of the slide card blank 310 to secure the panels ending in the suffix “a” to the panels ending in the suffix “b” when the slide card blank 310 is folded along the fold line 340. Alternatively, the panels may be secured together by means for securing described above or by heat-sealing processes, hot-glues and adhesives, all known and foreseeable types of mechanical fasteners including engaging elements, all known and types of chemical bonding, and any combinations thereof.

Thereby, the exemplary slide card 400 is formed as shown in FIG. 4. Specifically, the engaging tabs 320a, 320b are secured together to form a composite engaging tab 420, the base panels 322a, 322b are secured together to form a composite base panel 422, the spine panels 324a, 324b are secured together to form a composite spine panel 424, and the cover panels 326a, 326b are secured together to form a composite cover panel 426. The engaging tab 420, the base panel 422, the spine panel 424, and the cover panel 426 are hingedly connected one to the next along fold lines 430, 432, 434. The fold line 430 is defined by fold lines 330a, 330b, the fold line 432 is defined by fold lines 332a, 332b, and the fold line 434 is defined by fold lines 334a, 334b. In alternative embodiments, the slide card includes only a base panel and an engaging tab that are hingedly connected along a fold line.

Referring to FIG. 4, the engaging tab 420 includes a distal edge 428 that is provided at the distal end of the engaging tab 420. The distal end of the engaging tab 420 is that which is distal to the hinged connection between the engaging tab 420 and the base panel 422 along fold line 430. The hub 312 includes a distal edge 440 that is disposed adjacent to the distal edge 428 of the engaging tab 420. In the exemplary embodiment, the distal edge 440 of the hub 312 extends beyond the distal edge 428 of the engaging tab 420 so as to provide the distalmost or engaging edge E of the engaging tab 420.

It should be understood that the hub 312 is dimensioned and positioned such that the distal edge 440 extends at least to the distal edge 428 of the engaging tab 420 to reinforce or otherwise provide the engaging edge E for the engaging tab 420. Specifically, in embodiments where the distal edge 440 reinforces or substantially aligns with the distal edge 428, the distal edges 428, 440 together define the engaging edge E.

The position of the aperture A3 in the engaging tab 320a, the position of the protrusion 342 on the hub 312, the dimensions of the engaging tab 320, and the dimensions of the hub 312 at least partially determine the position of the distal edge 440 of the hub 312 relative to the distal edge 428 of the engaging tab 420. Thereby, the aperture A3 and the protrusion 342 provide means for positioning the distal edge 440 of the hub 312 with respect to the distal edge 428 of the engaging tab 420.

FIG. 5 illustrates an exemplary package 500 formed from the outer sleeve 12 and the slide card 400 according to the present invention. To construct the package 500, the following method, which is presented for purposes of teaching and not limitation, is described. Beginning with the folding of the slide card 400, the slide card 400 is folded inwardly along fold lines 432, 434 such that the cover panel 426 is substantially parallel to the base panel 422 and such that the spine panel 424 extends between and substantially perpendicular to the panels 422, 426 so as to form an end wall, as described in further detail below. In this configuration the blisters 350 are sandwiched between, and protected by, the cover panel 426 and base panel 422. The engaging tab 420 is then folded inwardly along fold line 430 so that the engaging tab 420 is at an acute angle with respect to the base panel 422. In alternative embodiments, the engaging tab 420 is folded outwardly, or in the opposite direction, so that the engaging tab 420 is disposed at an angle with respect to the base panel 422. In either position, the engaging edge E of the engaging tab 420 points generally toward the end wall defined by the spine panel 424.

Referring to FIG. 5, to insert the slide card 400 into the outer sleeve 12, the edge of the slide card 400 that is formed by the fold line 430 is positioned toward the open end of the outer sleeve 12. The outer sleeve 12 is oriented such that the engaging edge E is matingly aligned with the edge E2 of the engaging aperture 86 of the inner panel 20 (best shown in FIG. 2). The slide card 400 may then be fully inserted into the outer sleeve 12 between inner panel 20 and bottom panel 22, so that the engaging edge E releasably engages the edge E2 of the engaging aperture 86. In this configuration, the slide card 400 is fully encased by, and releasably locked in, the outer sleeve 12. When the slide card 400 is fully inserted in the outer sleeve 12, the spine panel 424 closes the open end of the sleeve 12 and thereby forms an end wall closure for the sleeve 12 that is opposite the end wall closure 104. Further, the edge of the slide card 12 that is defined by the fold line 430 is adjacent to or can abut the innermost vertical edge of the false end wall 102.

The engagement of the slide card 400 and outer sleeve 12 is now further discussed in further detail with reference to FIGS. 2 and 5. When folded along fold line 430, the resilience of the slide card 400 causes the engaging tab 420 to resist the fold and inherently spring back toward its unfolded position. This spring resistance holds the engaging edge E of the folded engaging tab 420 against the inner panel 20 wherein, when the slide card 400 is fully received in the outer sleeve 12, the engaging edge E of the engaging tab 420 can be received in the engaging aperture 86. Specifically, the engaging edge E of the engaging tab 420 abuts a portion of an edge E2 of the inner panel 20 that is defined by the engaging aperture 86 such that the slide card 400 is releasably locked in the outer sleeve 12. Further, this connection between the edge E2 defined by the engaging aperture 86 and the engaging edge E of the engaging tab 420 prevents the slide card 400 from being removed from the outer sleeve 12 unless the release button 90 is depressed. In the exemplary embodiment, the release button 90 and the node 88 cooperate such that, when the release button 90 is depressed, the release button 90 and the node 88 deflect into the outer sleeve 12 thereby pushing against the engaging tab 420 to release the engaging edge E from the edge E2 of the engaging aperture 86. The slide card 400 may then be at least partially withdrawn from the outer sleeve 12. In the exemplary embodiment, as the slide card 400 is withdrawn, the spring resistance of the engaging tab 420 holds the engaging edge E of the engaging tab 420 against the inner panel 20 such that the engaging edge E abuts an edge of, or otherwise the engaging tab 420 interlocks with, the inwardly folded extension panel 54 so as to prevent the slide card 400 from being fully removed from the outer sleeve 12.

In the illustrated embodiments, the hub 312 is formed of a substantially durable and formable material, such as, but not limited to, plastic, metal, ceramic, wood, or combinations thereof, to withstand the wear that occurs as the engaging edge E is repeatedly engaged with the edge E2 of the engaging aperture 86 as the slide card 400 is repeatedly inserted into and removed from the outer sleeve 12. Further, material that is used in either thermoforming or cold-forming processes are suitable for forming the hub 312. As described above, the distal edge 440 of the hub 312 protrudes from the engaging tab 420 to prevent the distal edge 428 from contacting, and thus delaminating from repeatedly contacting, the edge E2 of the engaging aperture 86. In addition, the hub 312 supports or otherwise stiffens the engaging tab 420 to prevent the engaging tab 420 from bending or otherwise becoming inoperable as the release button 90 is depressed to release the slide card from the outer sleeve 12.

The false end wall 102 enhances the structural integrity of the outer sleeve 12 by providing a brace between the top and bottom walls 224, 222 of the outer sleeve 12 and thereby allows the outer sleeve 12 to be more resistant to deformation from squeezing or crushing. Squeezing or crushing the outer sleeve 12 can inadvertently disengage the locking mechanism of the package, thereby providing inadvertent access to the items therein. As best illustrated in FIG. 2, the false end wall 102 obstructs an opening at one end of the tubular structure T to additionally prevent the articles in the package from being inadvertently accessed.

When the extension panels 50, 54 are folded and secured as described above, the edges of the apertures A1, A2, define notches at the open end of the outer sleeve 12 to facilitate removal of the slide card 400. The aperture A1 is substantially centered with respect to inner panels 20 and the aperture A2 is off center with respect to the bottom panel 22. Thus, the notch that is defined by aperture A1 aligns with the notch N1 when the panels 20, 24 overlap to form the outer sleeve 12 and the notch that is defined by the aperture A2 is offset from or is otherwise intentionally misaligned with the notch defined by the aperture A1 and with the notch N1 with respect to the perpendicular direction between the top and bottom walls 224, 222. The offset relationship between the notches provides an additional child-resistance feature in that, to open the package, the user must grasp the slide card 400 at the positions defined by the offset notches. Grasping the slide card 400 in this manner requires asymmetric placement of the fingers, which is counter-intuitive to children, and thus their ability to grasp and withdraw the slide card 400 from the outer sleeve 12 is greatly reduced. It should be understood that the position of the apertures A1, A2 as well as the position of the notch N1 can be varied such that the notches along the edges of the open end of outer sleeve 12 are offset from one another to produce the same relationship. For example, the location of the notches may be varied depending on the overall dimensions of the package.

In alternative embodiments shown in FIGS. 6-9 and FIGS. 10-11, an alternative slide card and an alternative outer sleeve each include elements that are substantially similar to elements of the slide card and outer sleeve that are illustrated and described in the first embodiment. Accordingly, like references are used for the alternative embodiments. Therefore, certain of the elements of the alternative embodiments may be sufficiently described by the description of the corresponding element in the first embodiment and, for clarity, such elements of the alternative embodiments will not be described in detail. Rather, the description of the alternative embodiments will focus on the differences between the embodiments.

Referring to FIG. 6, an alternative embodiment of an outer sleeve blank 610 is shown that can be folded and secured to form an outer sleeve 612, best shown in FIG. 9. The outer sleeve blank 610 is substantially similar to the outer sleeve blank 10 except that the edge E2 is defined by a cutout portion or contoured edge of inner panel 620. It should be understood that in the embodiments described herein, the edge E2 can be defined by one or more panels, tabs, ribs, abutments, cutouts, apertures, a combination of these, and the like.

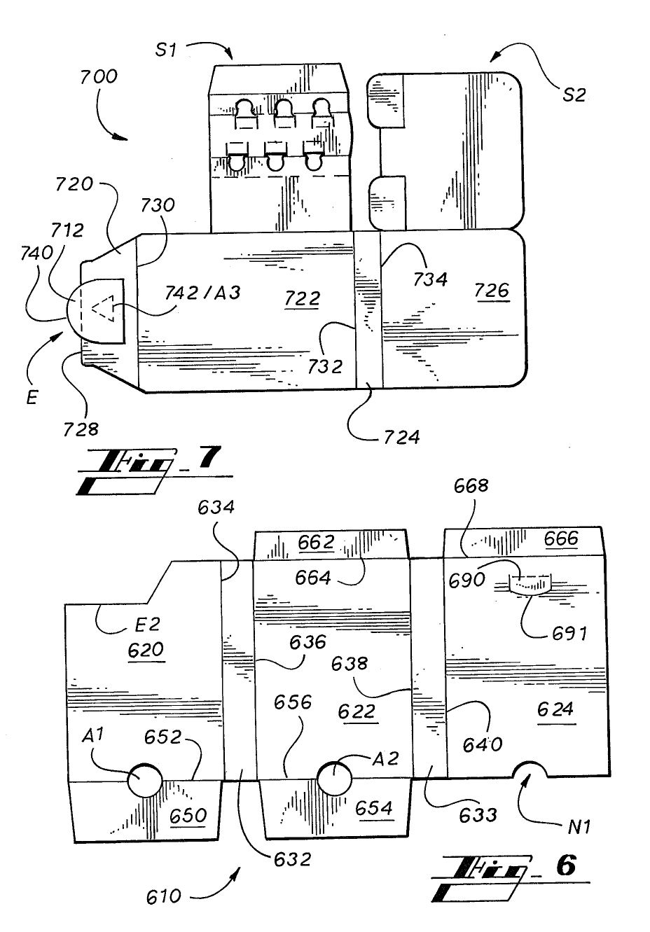

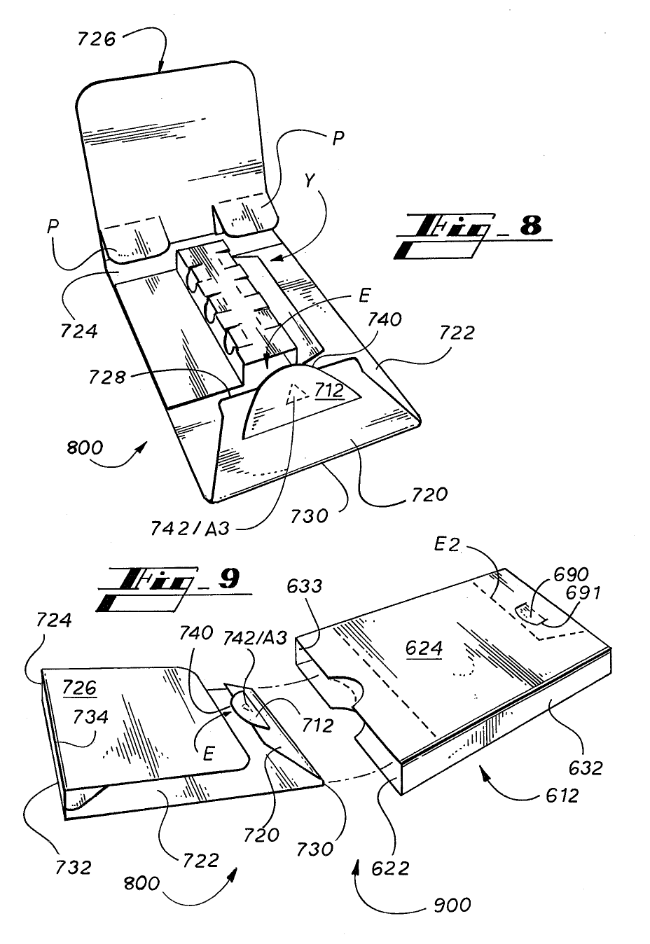

Referring to FIG. 7, a slide card blank 700 is shown that can be folded and secured to form a slide card 800 (shown in FIG. 8). The slide card blank 700 includes structure panels S1, S2 which include features that define an integral tray Y and spine panel support structures P, respectively. Specifically, the structure panel includes a pattern of apertures, fold lines, and cutlines that define the integral tray Y. The structure panel S2 includes fold lines and cut lines that define the spine panel support structures P. Referring to FIG. 7, it should be noted that a triangular shaped protrusion 742 of the hub 712 is received in a triangular shaped aperture A3 of engaging tab 720. The engaging tab 720 is formed from a single ply of paperboard or other material and the hub 712 is secured to the engaging tab 720 by adhesive or other means for securing as described above. Referring to FIG. 9, the slide card 800 can be inserted and releasably locked in the outer sleeve 612 to form the package 900.

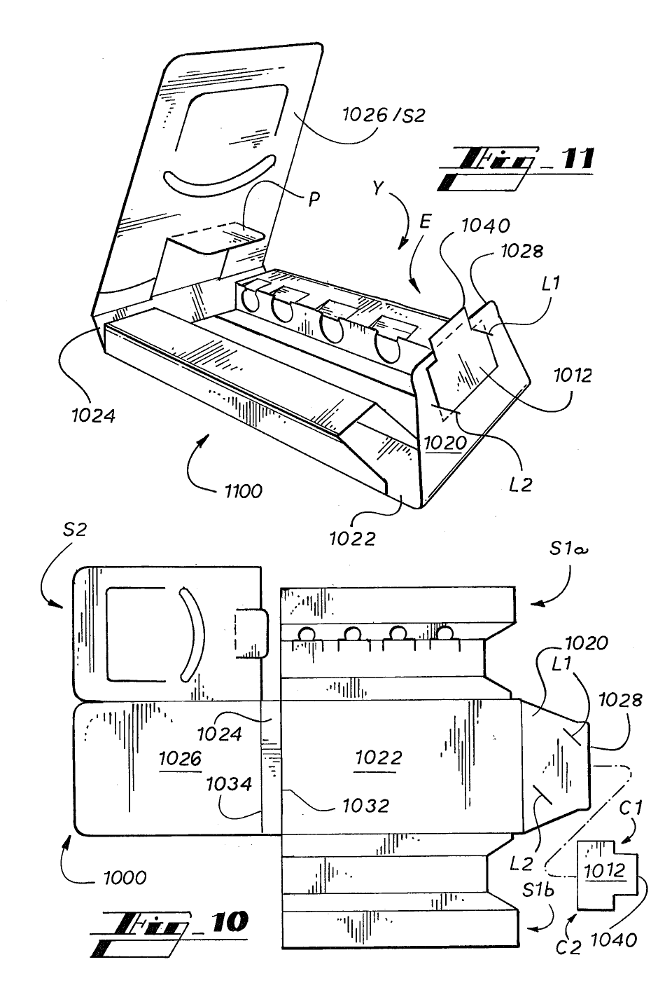

Referring now to FIGS. 10 and 11, a slide card blank 1000 is shown that can be folded and secured to form a slide card 1100. The slide card blank 1000 includes alternative embodiments of structure panels S1a, S1b, S2 which include features that define an integral tray Y and spine panel support structures P. The engaging tab 1020 includes slits L1, L2 that are dimensioned and positioned to receive corners C1, C2 of the hub 1012. Thereby, the hub 1012 is releasably secured to the engaging tab 1020 and the distal edge 1040 of the hub 1012 is positioned relative to the distal edge 1028 of the engaging tab 1020.

The trays Y of the slide cards 800, 1000 are configured to receive and house articles such as syringes, vials, ampoules, test tubes, and similarly shaped elongated components. However, as described above, the trays Y can be designed to receive and house any of other shapes and sizes.

The present invention offers advantages in that it is lightweight, tamper resistant, senior friendly, durable, easy to assemble, economical, and offers protection of the articles contained therein. Moreover, the invention provides a child resistant, yet user-friendly, unit dose packaging container that may be used to contain and dispense a variety of products. The improved tamper resistant features of the package may be attributed, at least in part, to the presence of the false bottom structural support, the offset notch placement, and the use of partially or fully laminated structural materials in construction of the package sleeve and slide card.

It must be emphasized that the law does not require and it is economically prohibitive to illustrate and teach every possible embodiment of the present claims. Hence, the above-described embodiments are merely exemplary illustrations of implementations set forth for a clear understanding of the principles of the invention. Many variations and modifications may be made to the above-described embodiments without departing from the scope of the claims. All such modifications, combinations, and variations are included herein by the scope of this disclosure and the following claims.

What is claimed is:

1. A slide card that can be releasably locked in an outer sleeve, said slide card comprising:
a base panel;
an engaging tab hingedly connected to said base panel, said engaging tab having a distal edge;
a hub being secured to said engaging tab, said hub having a distal edge;
wherein said hub is positioned relative to said engaging tab such that said distal edge of said hub at least partially provides an engaging edge of said engaging tab.

2. The slide card of claim 1, wherein said distal edge of said hub is the distalmost edge of said engaging tab.

3. The slide card of claim 1, wherein said distal edge of said hub is aligned with the distal edge of the engaging tab to define the engaging edge of said engaging tab.

4. The slide card of claim 1, wherein said hub and said engaging tab include means for positioning said hub relative to said engaging tab.

5. The slide card of claim 4, wherein said hub includes a protrusion and said engaging tab includes an aperture, wherein said protrusion is received in said aperture to position said distal edge of said hub relative to said distal edge of said engaging tab.

6. The slide card of claim 4, wherein said hub includes at least one corner and said engaging tab includes at least one slit, wherein said at least one corner of said hub is received in said at least one slit to position said distal edge of said hub relative to said distal edge of said engaging tab.

7. The slide card of claim 1, wherein said hub is secured to said engaging tab by means for securing.

8. A packaging system, comprising:
an outer sleeve including means for engaging;
a slide card, comprising:
a base panel;
an engaging tab hingedly connected to said base panel, said engaging tab having a distal edge;
a hub being secured to said engaging tab, said hub having a distal edge;
wherein said hub is positioned relative to said engaging tab such that said distal edge of said hub at least partially provides an engaging edge of said engaging tab.
wherein said engaging edge of said engaging tab engages said means for engaging such that said slide card is releasably locked within said outer sleeve.
